(19) United States
(12) Patent Application Publication
(10) Pub. No.: US 2007/0102038 A1
(43) Pub. Date: May 10, 2007

(54) Holding Element For Photovoltaic Modules

(76) Inventor: Christian Kirschning, Dusseldorf (DE)

Correspondence Address: CHADBOURNE & PARKE LLP, 30 ROCKEFELER PLAZA, NEW YORK, NY, 10112, US

(21) Appl. No.: 11/558,659

(22) Filed: Nov. 10, 2006

(30) Foreign Application Priority Data
Nov. 11, 2005 (DE) 102005054315.4
Jul. 17, 2006 (EP) 06014826.9

(51) Int. Cl. H02N 6/00

(52) U.S. Cl. 136/251

(57) ABSTRACT

The present invention relates to a method for establishing a sensor network having multiple sensor nodes, sensor nodes being able to connect to one another to transmit sensor data to a central receiving node, and information, in particular time information, being in stored in every sensor node from other neighboring sensor nodes lying in the reception area of a sensor node, on the basis of which a sensor node determines when to connect to another sensor node, initial information in the sensor node (S2) being formed by information from a mobile installation device (MGW), which is transmitted into a new sensor node (S2) during the installation thereof, the information particularly being provided in the form of a table.

### RELATED APPLICATIONS

This disclosure claims priority to German Patent Application No. 10 2005 054 315.4 filed on Nov. 11, 2005, and European Patent Application No. 06014826.9 filed on Jul. 17, 2006, both of which are hereby incorporated by reference.

### FIELD OF THE INVENTION

The invention relates to a holding element for photovoltaic modules for fastening at least one photovoltaic module to a holding device. The invention furthermore relates to a photovoltaic module as well as a system comprising at least one holding element and at least one photovoltaic module and furthermore also a process for the electrical connection of photovoltaic modules to holding elements.

### BACKGROUND

Photovoltaic modules are understood to mean devices with which electrical energy can be obtained from sunlight. In this connection, photovoltaic modules are often constructed as a framed or unframed glass laminate, with an electrical connection disposed on the photovoltaic module in order to access the voltage and/or power generated by the particular module. Photovoltaic modules are often mounted at sites favored by the sun, for which corresponding fastening devices can be provided.

A fastening device can, for example, be disposed on a roof or a wall of a house, but separate fastening devices, e.g., standing on a free field, are used in order to expose one or more photovoltaic modules to solar radiation or other light sources. It is also a known practice to equip a fastening device in such a manner that the photovoltaic modules fastened thereto can track the sun or another light source.

In order to fasten photovoltaic modules to a fastening device it is furthermore a known practice to use holding elements with which a photovoltaic module can be engaged in order to achieve a connection between the photovoltaic module and the fastening device.

### SUMMARY OF THE INVENTION

Depending on the application, photovoltaic modules are connected in series or in parallel. Photovoltaic modules customarily comprise, as stated above, an electrical connection in the form of cables disposed on the photovoltaic module, where, after the fastening of the modules in/on a holding element of a fastening device, said cables are customarily installed so as to be freely suspended in order to ensure the electrical connection of the photovoltaic modules to one another. These freely suspended cables are exposed to wind and weather and accordingly represent a delicate element of a photovoltaic module.

It is an objective of the invention to provide holding elements or photovoltaic modules or a system of such and a process for the electrical connection of photovoltaic modules, said process providing a problem-free, simple, low-maintenance, and reliable capability of electrically contacting photovoltaic modules, in particular electrically connecting, and in so doing also mechanically holding, them to one another.

This objective is realized according to the invention by a holding element which comprises at least one receiving area in order to engage an edge of at least one photovoltaic module, where at least one connecting element is disposed in or neighboring a receiving area. Thereby it is ensured that at least one connecting element, on inserting and/or plugging a photovoltaic module onto/into the holding element, is electrically connected to at least one connecting element disposed on a photovoltaic module.

According to another aspect of the invention the objective is realized by a photovoltaic module with at least one electrical connecting element, where at least one connecting element, on inserting and/or plugging the photovoltaic module onto/into a receiving area of a holding element, is electrically connected to at least one connecting element disposed in or neighboring the receiving area.

According to another aspect of the invention the objective is realized by a process in which at least one photovoltaic module is inserted and/or plugged into at least one receiving area of at least one holding element, whereby an electrical and mechanical connection is automatically produced between at least one connecting element of the photovoltaic module and at least one connecting element of at least one holding element, said connecting element being disposed in, at, or neighboring a receiving area.

According to one aspect of the invention a holding element as well as a photovoltaic module comprises connecting elements corresponding to one another, e.g., plug connectors and jacks, where it is irrelevant for the invention at which element the plug connector(s) or jack(s) is/are disposed so that a simple and in particular reliable electrical connection, in particular of several photovoltaic modules to one another, the photovoltaic modules are plugged into or inserted into holding elements, whereby an electrical and also a mechanical connection between a photovoltaic module and a holding element is produced automatically, in particular where with several photovoltaic modules an electrical connection at least of a part of the photovoltaic modules, in given cases of all photovoltaic modules, with one another is produced.

A holding element also provides, along with a secure mechanical fastening in the receiving area provided therefore, for a secure electrical contact by at least one connecting element which is disposed in or neighboring this receiving area.

A mechanical connection between the module and the holding element can also be made by the connecting elements which are provided for the electrical connection.

Due to the direct, at least electrical but in given cases also mechanical, connection of the connecting elements provided in each case, cable connections can be omitted completely so that environmental influences on the connecting elements remain essentially negligible. In particular there are no more loose connecting cables hanging around which are constantly moved by wind and weather and, for example, can become brittle or prone to damage in some other manner. In particular, the connecting elements can be formed on the holding element and photovoltaic modules in such a manner that they are formed after connection to one another, e.g., after plugging one connecting element into another in a watertight manner.

Thus, with the photovoltaic modules according to the invention and the holding elements according to the invention, fastening devices can be realized in a simple manner to which photovoltaic modules can be connected mechanically, and also electrically, to one another. The holding elements according to the invention which mechanically hold and electrically contact photovoltaic modules can be fastened to these fastening devices.

Thus, by means of a holding element according to the invention, or a plurality of the holding elements according to the invention, a greater array of photovoltaic modules, i.e., an arrangement of photovoltaic modules with one next to one another, or one over one another, can be achieved. For this, essentially only one substructure is necessary, e.g., a fastening device with which the individual holding elements are held at an, in particular, fixed but in given cases also variable, distance from one another in order to be able to fasten the photovoltaic modules to the holding elements in a corresponding receiving area.

There, in order to achieve a mechanical hold, a holding element can be embodied, in regard to its implementation from the standpoint of construction, in the customary manner, for example, as is known in the state of the art. According to one embodiment of the invention, the automatic electrical connection between the holding element and the photovoltaic module is made by fastening of these elements to one another. And, the connecting elements are disposed in or neighboring a receiving area to allow mechanical loads of the electrical connecting elements can be kept very low.

According to an advantageous embodiment it can, for example, be provided that a holding element is formed as a profile in order to engage at least one photovoltaic module on a face or edge. In another alternative it can also be provided that a holding element is formed to engage at least one photovoltaic module on/in a comer area.

With forming a holding element as a profile which engages a photovoltaic module at a face and/or edge, for example, two holding elements are needed which are disposed parallel to one another in order to engage a photovoltaic module on sides running parallel to one another, here in particular at the edge area.

In fastening photovoltaic modules to holding elements of this type, said holding elements having the form of a profile and serving to engage an edge or a face, it is not absolutely necessary that each individual holding element be embodied according to the concept according to the invention, i.e., comprise corresponding connecting elements, for example, a plug connector or a jack with several electrical connections. In this connection it can be provided that only a few of the holding elements for holding a photovoltaic module contribute to an electrical connection.

It is, for example, provided that photovoltaic modules are held on an edge or face so that it is sufficient that the electrical connection to the particular module takes place only in the holding elements on one of the two sides and the opposite holding element merely forms the mechanical connection.

According to an additional preferred embodiment it can be provided that several photovoltaic modules can be engaged with one holding element, where one holding element can comprise several connecting elements and in each case at least one connecting element is assigned to a photovoltaic module to be engaged. Thus, e.g., with reference to holding elements for engaging a photovoltaic module on one side or on an edge area, several connecting elements of the holding element can have a periodic distance from one another, in particular where a distance essentially corresponds to a width and/or length of a photovoltaic module, in given cases in addition to an intended spacing between the respective photovoltaic modules. Thus, at the distance of this provided periodicity of the connecting elements several photovoltaic modules can accordingly be fastened to such a holding element, mechanically as well as electrically.

The use of the connecting elements specified here can comprise several electrical contact elements, specifically at least two, in order to define positive and negative potential. In given cases it can be provided that four contact elements are provided, specifically two contact elements which produce a connection of a photovoltaic module to a preceding module and two additional contact elements which produce an electrical connection to a subsequent photovoltaic module.

Likewise, in given cases only one electrical contact element can be provided in one connecting element. Then there are on one holding element or photovoltaic element at least two connecting elements, one for positive and one for negative potential. The type of contact or electrical connection depends here essentially on the desired electrical conductor arrangement in the holding element, where said electrical conductor arrangement is within the holding element.

In an additional embodiment, in particular if holding elements are provided, in order to engage at a lateral edge area of a photovoltaic module, it can be provided that several holding elements can be connected to one another, in particular in such a manner that they can be plugged in and removed, in particular where the connecting elements of the holding elements can be electrically contacted with one another in order to form a longer holding element in which several photovoltaic modules can be fastened.

Thus it can accordingly be provided that one holding element, depending on the fastening, is consistent with the width or the length of a photovoltaic module to be fastened thereto, or has a greater length, where it is then provided for mounting several photovoltaic modules next to and/or over one another that the holding elements are connected to one another in order to form a longer holding element formed accordingly therefrom. For this it is necessary to also continue the electrical connection from one holding element to another, for which, at the connection points of the holding elements to one another, electrical connecting elements can also be provided. Thus a connection can be produced by a mechanical plug-in and/or snap-on connection which simultaneously also provides for the electrical connection.

Independently of whether a holding element comprises at least one connecting element in order to electrically contact a single photovoltaic module, or several connecting elements in order to contact several photovoltaic modules, it is, as mentioned above, preferably provided that the arrangement of electrical conductors between different connecting elements is preferably done within one holding element or several connected holding elements.

In a particularly preferred embodiment which can be combined with all the other constructions stated previously, it can be provided that on one holding element a circuit device is provided by means of which it can be determined whether photovoltaic modules are connected electrically in series or in parallel by means of the holding element. With a holding element of this type it can accordingly be determined whether, in an, e.g., greater, array of several photovoltaic modules, these modules are all connected in series or in parallel or array areas are connected in series or in parallel. Likewise, there is thus the possibility of in turn connecting in parallel to one another a first array area in which all the photovoltaic modules are connected in series and a second array area in which all the photovoltaic modules are also connected in series.

Holding elements according to the invention are distinguished by the fact that they comprise at least one receiving area in order to engage an edge area of at least one photovoltaic module. There it can be provided that the edge area of a photovoltaic module is engaged or engaged in an enveloping manner if a relative motion between the holding element and photovoltaic module takes place, in particular in or parallel to the plane of the photovoltaic module. This can be done in particular in such a manner that a holding element is disposed in parallel to an edge of a photovoltaic module and the holding element can be moved in the direction perpendicular to its longitudinal extension or perpendicular to the edge of the photovoltaic module.

In such an embodiment it can be advantageous if a holding element according to the invention is disposed in such a manner that it is at a distance from, and can be moved relative to, another holding part. In this way, through a motion of one of the holding element and the holding part relative to the other, a photovoltaic module can be engaged between them and thus mechanically fastened and electrically contacted. In so doing, such a relative motion can preferably be done in the direction perpendicular to the longitudinal extension of the holding element and holding part. They are preferably disposed parallel to one another. Here it can also be provided that the holding part is also formed as a holding element according to the invention.

This can be achieved, for example, by the holding element being disposed by means of a fastening device or spacer at a distance, in particular in parallel to a holding part, where at least the holding element or at least the holding part is formed in such a manner that it can be displaced, so that the distance between them can be changed.

In such a construction a photovoltaic module can subsequently be slightly distanced from the fastening device/spacer, e.g., by the holding element and/or the holding part being displaced, whereby the distance is increased, the electrical contact is broken, and the module can be removed.

A receiving area of a holding element according to the invention but also an aforementioned holding part without the electrical contact can, for example, be formed by two walls areas/walls at a distance from one another, whose distance corresponds essentially to the thickness of a photovoltaic module or its edge. In given cases it can be taken into account here that in a receiving area an elastomeric element, e.g., of rubber, is received in order to engage a photovoltaic module be means of the rubber element and not directly with the holding element.

A receiving area can, for example, be formed as a slot which is suitable to engage in an enveloping manner an edge area of a photovoltaic module. Along with this, it is provided according to the invention that at least one connecting element is disposed which according to the previous embodiments can comprise one, two, or more contact elements in or neighboring a receiving area.

A possible preferred embodiment is seen in a receiving area being formed as a slot, where parallel to the slot a cable duct is disposed which is connected to the interior of the slot via at least one recess in the base of the slot. Here the cable duct can be formed by an open slot which can be closed with a cover element.

This embodiment has the advantage that a particularly simple cable installation can take place, for example, by an, in particular prefabricated, cable harness or a cable being laid into the open cable duct. Here it can be provided that on the cable/cable harness at least one connecting element, preferably a plurality of connecting elements, is disposed, in particular which are disposed via cable pieces on the cable/cable harness. Such a connecting element can then be inserted into a recess directly or via an, in particular elastomeric, intermediate piece, whereby it can be fastened, in particular in a force-locking, form-locking, or material-locking manner, in a recess. Thereafter the open cable duct can be closed with the cover element.

The recesses in the base of the slot preferably have a spacing which corresponds to the distance of the connecting element to the photovoltaic modules so then a desired number of photovoltaic modules can be inserted into a holding element assembled in this manner.

In another embodiment it can be provided that a recess is formed as a port, in particular over the entire length of the slot and/or of the cable duct. In this embodiment the cable duct can be formed without an additional cover element since in this embodiment equipping of the cable duct with a cable and/or cable harness can be done through the port in the slot wall. Also here it can then be provided that connecting elements of the cable and/or cable harness can be inserted into the port, in particular where a necessary distance can be marked or still more recesses are provided in the port into which the connecting elements can be set directly or each via an, in particular elastomeric, intermediate piece.

Thus it can be ensured thereby that the connecting element is mounted elastically in a recess so that position tolerances, loads, or different extensions between the holding element and the photovoltaic module can be compensated. Alternatively, or also in addition, a contact element can be mounted elastically in a connecting element.

In a further possible embodiment it can be provided that a holding element comprises two slots running in parallel which are open on opposite sides, in particular where between the slots a cable duct is disposed which is connected to the interior of at least one of the slots via at least one port-like recess in the base of a slot. Also here there is, as described above, the possibility of assembly of the cable duct through the port in the base of at least one of the two slots. The embodiment furthermore has the advantage that one of the slots serves for holding and contacting a first photovoltaic module, where the slot open to the other side serves for holding, and in given cases also for contacting, a second neighboring photovoltaic module.

A photovoltaic module corresponding to an aforementioned holding element comprises at least one corresponding connecting element which, in one form of embodiment, is disposed neighboring the edge, e.g., an edge or face of the photovoltaic module, or directly at the edge of a photovoltaic module, e.g., in the center relative to one side or in a corner area. In particular, if it is provided to dispose a connecting element in the vicinity of the edge or a comer, this is preferably done on the underside of the photovoltaic module.

By means of the holding elements according to the invention or the photovoltaic modules according to the invention a modular system can be constructed in a simple manner comprising corresponding holding elements and photovoltaic modules which each comprise connecting elements corresponding to one another, e.g., plug connectors and/or jack elements, so that an electrical connection between a holding element and a photovoltaic module can be produced by means of an, in particular disconnectable, connection between the plug connector and jack, preferably without any cable connection.

With regard to all the embodiments it is to be stated that the technical features named in connection with an embodiment can be used not only in that specific embodiment but rather also in each of the other embodiments. All the disclosed technical features of this description of the invention are to be classified as essential to the invention and can be used alone or in any combination with one another.

By means of a modular system of this type different sizes of arrays of photovoltaic modules can therefore be constructed in a simple manner. In this connection it can be provided that a holding element with one or more additional holding elements is mechanically and/or electrically connected by means of a supporting element. Here, in particular through the supporting element which, for example, can be a part of a fastening device, or forms it entirely, it is ensured that the holding elements for engaging photovoltaic modules have a fixed, or in another embodiment variable at least by area, distance from one another.

### BRIEF DESCRIPTION OF THE DRAWINGS

Embodiment examples of the invention are represented in the following figures. Shown are:

FIG. 1 shows a possible embodiment with holding elements for engaging several photovoltaic modules on an edge.

FIG. 2 shows the arrangement of an electrical connecting element on a holding element outside of a receiving area.

FIG. 3 shows the arrangement of an electrical connecting element in a holding element within the receiving area.

FIG. 4 shows a positioning of the electrical connecting elements and mounting device.

FIG. 5 shows a holding element with a cable duct and a cover element.

FIG. 6 shows the forming of arrays of modules.

FIG. 7 shows a holding element with two receiving slots and a cable duct.

FIGS. 8 and 9 show the mounting sequence during the insertion of a cable harness into a cable duct.

### DETAILED DESCRIPTION

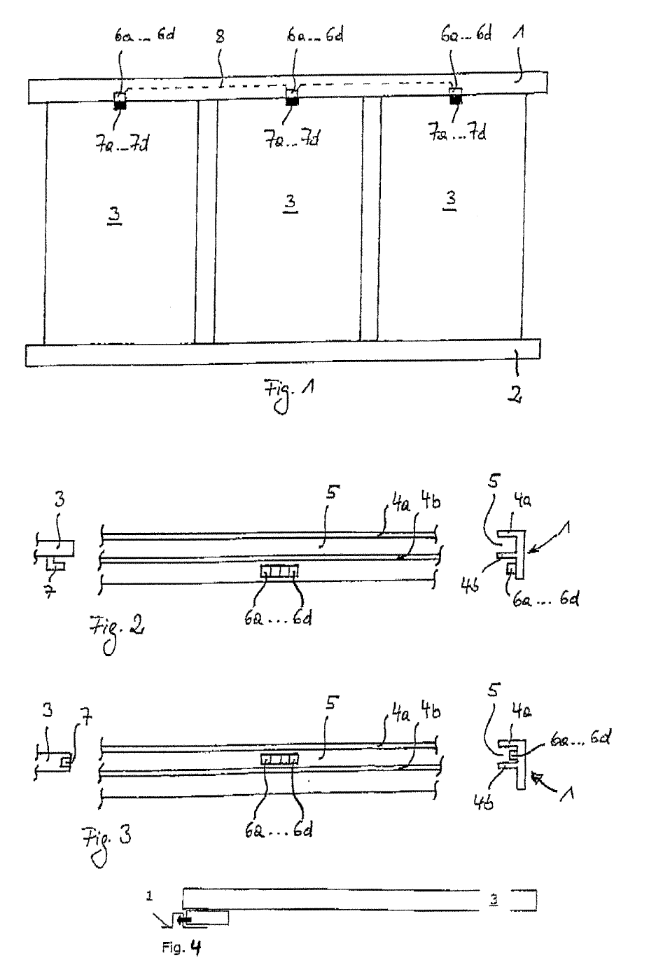

FIG. 1 shows in an exemplary, and here non-restrictive, view the sequential arrangement of three identical photovoltaic modules 3, which are each, for example, implemented as a glass laminate construction and according to the invention comprise in their upper edge area a plug connector which comprises a connecting element 7, with four contact elements 7a, 7b, 7c, and 7d in this case. The photovoltaic modules 3 shown here are provided to be received in holding elements 1 and 2, which run parallel to one another, at their respective edges.

Here the upper, relative to the image of FIG. 1, holding element 1 comprises at a somewhat greater distance than the width of one photovoltaic module 3 three corresponding connecting elements with four contact elements 6a to 6d, where the connecting elements are embodied, for example, as jacks 6. The three jacks 6 are connected to one another by means of lines 8 running in the holding element 1, said lines being represented here only schematically as dashed lines, in order to achieve a series circuit, or also a parallel circuit, depending on the circuit requirement, of the three photovoltaic modules 3 represented here by way of example.

It can be seen that for the mechanical fastening of the three photovoltaic modules 3 the two holding elements 1 and 2 are held parallel to one another and at a fixed distance from one another by a supporting structure or substructure not shown here. The electrical connection is produced merely by the upper holding element 1, which can be implemented as an elongated profile. The likewise elongated profile of the holding element 2 can contribute here merely to mechanical fastening.

FIGS. 2 and 3 show two different connection variants for the embodiment of FIG. 1. The possible implementation of a holding profile 1 of FIG. 1 can be seen in FIG. 2 in a cutout in top view and side view. Also represented on the left is the edge area of a photovoltaic module 3. It can be seen here that the holding element 1 comprises two projecting flanges or wall areas 4a and 4b which, with the rear area of the holding element 1, form a slot 5 to receive the edge of a photovoltaic module 3.

In this connection, but not as represented here, an elastomeric element can be disposed within the slot. Likewise, it can be provided that one of the wall areas 4a and 4b is disposed separately, i.e., not as one piece on the holding element, in order, for example, to achieve a clamping effect on the photovoltaic module in the edge area, as is customarily known in glass or façade construction. Below the slot 5 which is formed by the walls areas 4a and 4b, a jack 6 with electrical contact elements 6a and 6b is disposed.

It can be seen here in the lateral sectional representation of the photovoltaic module 3 that in the edge area below the photovoltaic module a spaced plug connector 7 projecting in the direction of the jack 6 is disposed which comprises an equal number of contact elements. In the present example four contacts are represented, where two are provided in order to contact a preceding photovoltaic module and two in order to contact a subsequent photovoltaic module. Depending on the circuit requirement, different numbers of contact elements can be provided here. In one embodiment, in particular with a series circuit, it can be sufficient to provide only two contact elements.

FIG. 3 shows by contrast an alternative in which the contact elements 6a to 6d of the connecting element 6, in the embodiment with four contacts or also in an equivalent form with only two contacts, are disposed within the slot 5 so that a photovoltaic module 3 corresponding thereto comprises a corresponding connecting element 7, e.g., a plug connector directly at its edge, as FIG. 3 shows on the left side.

In the two embodiments according to FIG. 2 and FIG. 3, on insertion of a photovoltaic module or its edge into the profile 1 represented here, an electrical plug-in connection between the connecting elements, i.e., here the plug connector 7 and jack 6, is also automatically produced along with a mechanical fastening in the receiving area of the slot 1 independently of the type of the arrangement of the plug connectors or jack in the holding element.

Relative to FIG. 1 an additional form of embodiment is possible which is not represented explicitly, specifically such that the holding element 1 or 2 is divided into three individual holding elements, each of which is separated at the spacing area between the photovoltaic modules 3. At these separation points there is the possibility of contacting the individual holding elements with one another mechanically as well as electrically, for which mechanical and/or electrical connectors can be provided at the corresponding contact points of the holding elements.

FIG. 4 shows a mounting variant in which the holding elements 1 and the connecting elements 6/7 are each disposed in the edge area relative to a photovoltaic module 3. Here FIG. 4 shows the possibility of achieving an electrical connection by a lateral insertion of a photovoltaic module 3 into a holding element. The direction of insertion thus lies parallel to the plane of the photovoltaic module. Here it is irrelevant whether the photovoltaic module moves to a stationary holding element or a holding element moves to a stationary photovoltaic module. The important point is that the relative motion causes an insertion or plugging in.

All the forms of embodiment of the photovoltaic modules or holding elements according to the invention shown here show the advantage according to the invention that an electrical connection of several photovoltaic modules with one another, or also the electrical connection of an individual photovoltaic element with an electrical environment by means of one or more holding elements, is possible without establishing a separate electrical cable connection between them. Due to the plug-in contact between the photovoltaic module and the holding element a particularly robust and mechanically less delicate construction for producing photovoltaic systems results.

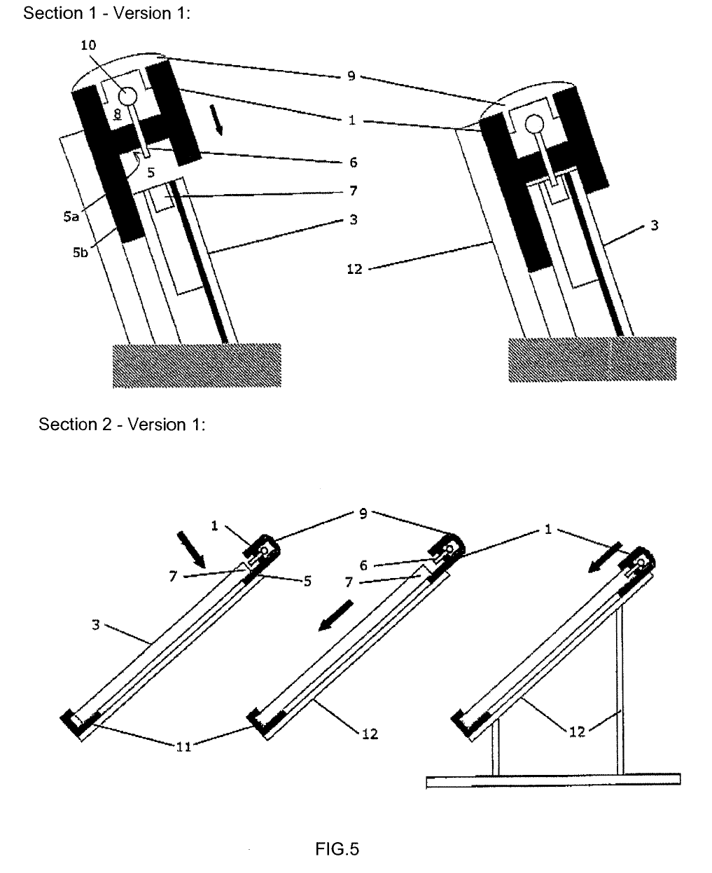

FIG. 5 shows an embodiment of a holding element according to the invention in detail and in overview. In the upper representation it can be seen that a holding element 1 is formed, e.g., as a profile, which can also be produced as an extrusion profile which is made, for example, of plastic or a metal (for example, aluminum), is of arbitrary length, and can be cut to length. It can be seen here that the holding element 1 comprises a slot 5 open towards the edge of a photovoltaic module 3, where one of its slot legs 5b is formed to be longer than the other in order to serve as a support for the photovoltaic module 3 before the slot 5 engages around the edge.

Parallel to the slot 5 a cable duct 8 is disposed which extends here preferably over the entire length of the slot parallel to it. The cable duct is open towards the side opposite to the slot and can be closed with a cover element 9. In the cable duct 8 a cable harness 10 can be laid in from above, i.e., from the open side of the cable duct 8, where connecting elements 6 are disposed on the cable harness 10 in order to provide the contact to a photovoltaic module 3.

In the slot base 5a, i.e., the wall which connects the leg of the slot 5, recesses are disposed, e.g., as through-holes, so that connecting elements 6, which can be formed here as plug connectors and are disposed on the cable harness, can project through these recesses into the interior of the slot. For this, the connecting elements 6 are inserted into the recesses in the base of a slot so that they are thus fastened, for example, in a form-locking manner, in a force-locking manner, or in a material-locking manner, e.g., by additional gluing.

In the lower overview of FIG. 5 it can be seen that an upper holding element 1 according to the invention is disposed parallel to and at a distance from another holding part 11. The holding element 1 and the holding part 11 can, for example, be connected by a fastening device, a spacer, or another substructure, where it is provided according to the invention that the holding element and the holding part can be displaced relative to one another so that the distance between them can be changed. In FIG. 5 the holding element 1 is mounted so that it can be displaced on the spacer.

Thus, a photovoltaic module can first be laid by its lower edge into a receiving area, e.g., a slot of the lower holding part 11, and lie with its upper edge on the extended edge of the slot 5. Then by displacing the holding element 1 the spacing between the holding element 1 and the holding part 11 can be reduced, whereby also the slot 5 of the holding element 1 engages around the upper edge of the photovoltaic module 3 and is mechanically fastened to it.

Here the plug connector of the connecting element 6 also automatically engages in the jack of the connecting element 7 on the photovoltaic module, whereby it is contacted.

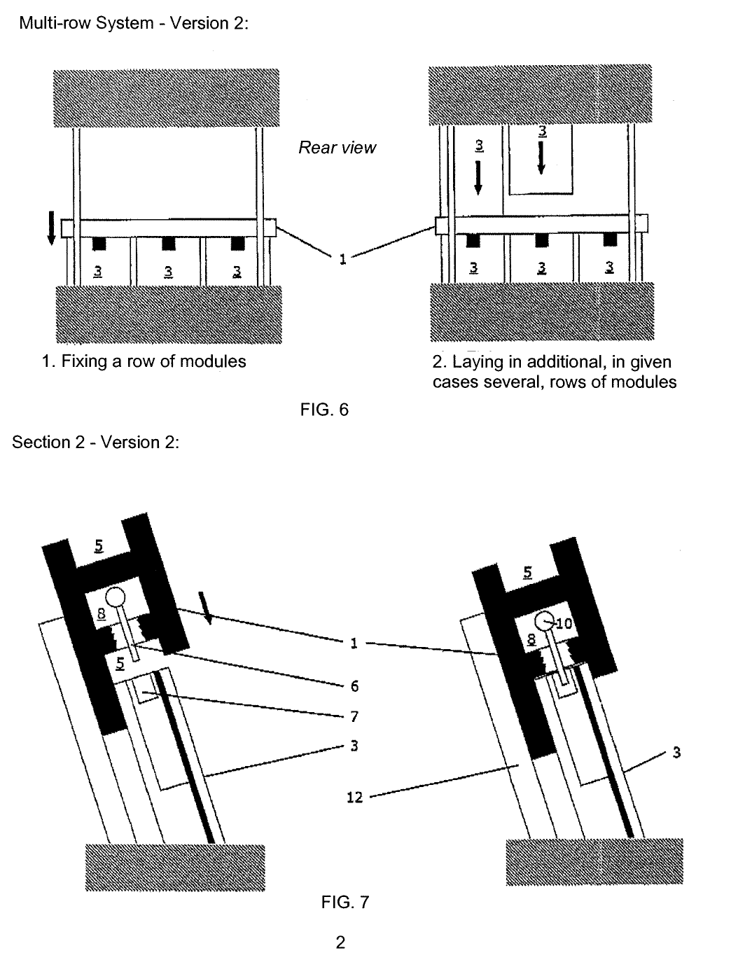

FIG. 6 shows a possibility of also producing larger arrays of photovoltaic modules 3. In a lower holding part not shown here photovoltaic modules are, in this example 3, laid in and mechanically fixed, and each also contacted, by displacement of the upper holding element 1 according to the invention. This type of displacement has been described with respect to FIG. 5 and applies here in an analogous manner.

The displaced holding element 1 offers on its upper side an additional receiving area, e.g., once again a slot, in order to receive the lower edge of a row of photovoltaic modules 3 disposed above it. Such a holding element 1 is described in more detail in FIG. 7.

In FIG. 7 one can see a holding element 3 in which two slots 5 are disposed parallel to one another in the same profile, where the slots are open towards opposite sides and serve to receive neighboring photovoltaic modules 3. The slots are thus formed as described in FIG. 5 with respect to holding element 1 and holding part 11.

Between the slots a cable duct 8 is disposed which, by means of a penetrating port in the base of a slot, is connected to one of the slots 5, in this case to the lower slot 5. Thus, a cable harness 10 can be laid into the otherwise closed cable duct 8 from below through the slot 5, where in turn the connecting elements 6 of the cable harness, as described previously, are then fastened, but now in the port instead of in the recesses. Otherwise, the displacement kinematics are as described with respect to FIG. 5. This embodiment of the holding element 1 has the advantage that the cable duct 10 is hermetically separated from the environment and the open port is also closed after fastening of an edge of a photovoltaic module 3.

In the embodiment of FIG. 5 the profile of the holding element 1 can be described as an H-profile, where preferably one leg of one of the slots is lengthened and in the central linking bar of the H several recesses disposed so as to be next to one another in the longitudinal direction are disposed to receive connecting elements.

In the embodiment of FIG. 7 the profile can be designated as an H-profile, in particular as in FIG. 5, where the central linking bar of the H-profile comprises a duct open as a port towards a slot.

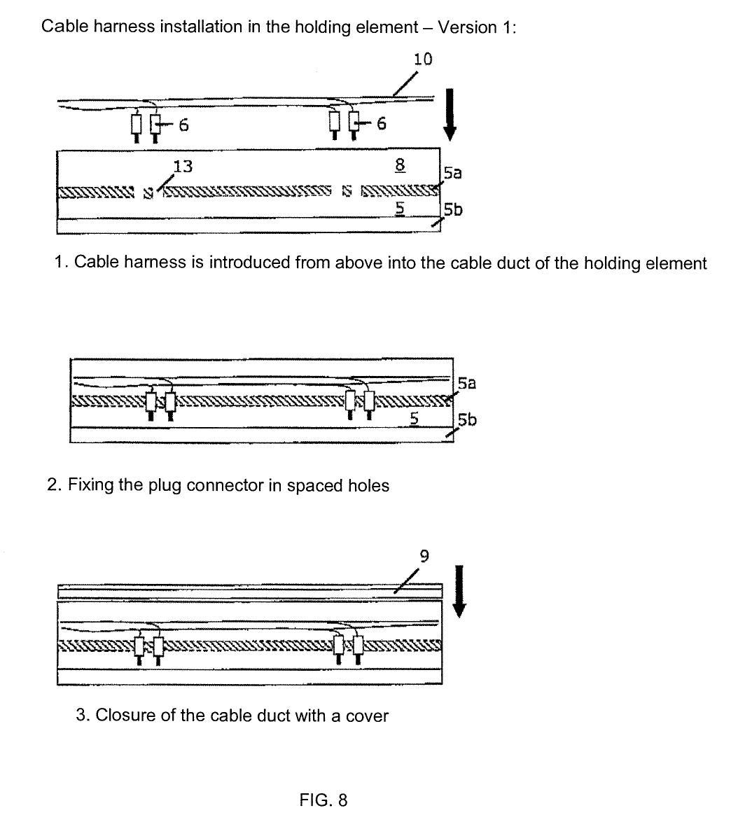

FIG. 8 illustrates the introduction of a cable harness 10 into a holding element 3 according to FIG. 5 in another sectional representation.

It can be seen here that the cable harness 10 with the connecting elements 6 can be laid into the upwards open cable duct 8 of the holding element. In so doing, the connecting elements 6 of the cable harness 10 are inserted into the recesses 13 in the slot base 5a. Subsequently the cover 9 is put on.

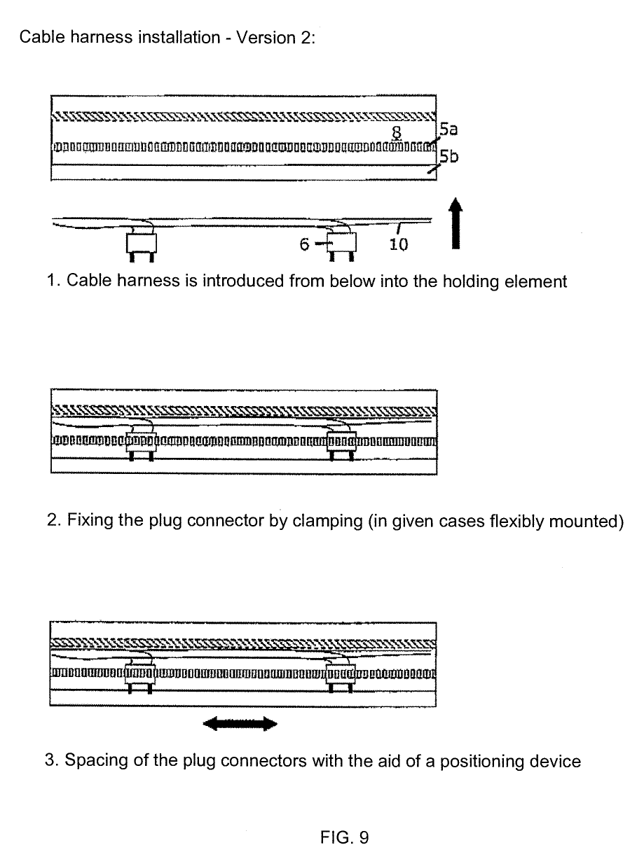

FIG. 9 illustrates the same situation in a holding element according to FIG. 7. Here the cable harness 10 is inserted through a port in the slot base 5a of the lower slot into the cable duct 8. The connecting elements 6 are fastened in the port, e.g., by clamping.

The connecting elements 6 of FIG. 9 are distinguished from those of FIG. 8 by the fact that in FIG. 9 a connecting element comprises two contact elements, where in FIG. 8 each connecting element 6 has only one contact element. Along with this, each connecting element can form an elastic mounting of the contact elements disposed in it, in FIG. 8 as well as in FIG. 9.

In FIG. 9 the spacing of the connecting elements can be performed with a positioning device. Likewise, it can be provided that markings are disposed at or in the port, or that in the port separate recesses are disposed once more for the connecting elements and the port serves only for the guiding through of the cable harness.

What is claimed is:

1. A holding element for photovoltaic modules comprising:
at least one receiving area disposed to engage an edge of at least one photovoltaic module, the photovoltaic module having a first connecting element; and
a second connecting element disposed in or adjacent to the receiving area wherein the insertion of the edge of the photovoltaic module into the holding element creates an electrical connection between the first connecting element and the second connecting element.

2. The holding element according to claim 1, wherein the holding element comprises a plurality of second connecting elements such that each second connecting element can connect to at least one first connecting element.

3. The holding element according to claim 2, wherein the plurality of second connecting elements are spaced at a distance from one another corresponding to the length of at least one edge of the photovoltaic module.

4. The holding element according to claim 1 wherein the holding element can be connected to other holding elements by plugging in the second connecting elements of the holding elements causing the holding elements to be electrically connected to one another.

5. The holding element according to claim 4 wherein the holding element can be connected to other holding elements in a series or parallel electrical connection.

6. The holding element according to claim 1 wherein the holding element further comprises a circuit to determine whether photovoltaic modules are connected electrically in series or in parallel.

7. The holding element according to claim 1 comprising:
a fastening device to mechanically and/or electrically connect the holding element at least one other holding element.

8. The holding element according to claim 1, wherein it is disposed in such a manner that it can be displaced relative to a holding part such as another holding element.

9. The holding element according to claim 8, further comprising a fastening device at a distance from the holding part where at least the holding element or at least the holding part is formed in such a manner that it can be displaced, so that the distance between them can be changed.

10. The holding element according to claim 1 wherein the receiving area is formed as a slot having a slot base and a cable duct is disposed parallel to the slot and is connected to the interior of the slot via at least one recess in the slot base.

11. The holding element according to claim 10, wherein the cable duct is formed by an open slot which can be closed by a cover element.

12. The holding element according to claim 10, wherein at least one second connecting element can be lockingly inserted into the recess.

13. The holding element according to claim 10, wherein the recess is formed as a port over the entire length of the slot and/or of the cable duct.

14. The holding element according to claim 10, wherein a contact element is mounted elastically in the second connecting element.

15. The holding element according to claim 1 further comprising:
two slots running in parallel which are open on opposite sides such that between the slots a cable duct is disposed which is connected to the interior of at least one of the slots via at least one recess in a slot base.

16. A Photovoltaic module comprising:
at least one electrical connecting element, the electrical connecting element disposed so that upon insertion of the photovoltaic module into a receiving area of a holding element the photovoltaic module is electrically connected to at least one complementary connecting element disposed in or neighboring the receiving area.

17. The photovoltaic module according to claim 16, wherein electrical connecting element is disposed on an edge of the photovoltaic module.

18. A system comprising:
at least one holding element comprising least one receiving area and a connecting element disposed in or adjacent to the receiving area; and
at least one photovoltaic module having a complementary connecting element;
wherein the receiving area is disposed to receive and hold an edge of the photovoltaic module and thereby create an electrical connection between the connecting element and the complementary connecting element.

19. A method for mounting a photovoltaic module within a holding element comprising:
inserting an edge of the photovoltaic module into a receiving area of the holding element thereby automatically creating an electrical connection between a connecting element of the photovoltaic module and complementary connecting element of the holding element, and thereby also making a mechanical connection between the photovoltaic module and the holding element.

20. The method of claim 19, further comprising inserting the edges of several photovoltaic modules into at least one holding element such that an electrical connection between at least part of the several photovoltaic modules is produced.
